(19) United States
(12) Patent Application Publication
(10) Pub. No.: US 2023/0110005 A1
(43) Pub. Date: Apr. 13, 2023

(54) DEVICE SELECTION METHOD AND INFORMATION PROCESSING APPARATUS

(71) Applicant: FUJITSU LIMITED, Kawasaki-shi (JP)

(72) Inventors: Hiroshi Endo, Fuji (JP); Shigeto Suzuki, Kawasaki (JP); Hiroyoshi Kodama, Isehara (JP); Takahide Yoshikawa, Kawasaki (JP)

(73) Assignee: FUJITSU LIMITED, Kawasaki-shi (JP)

(21) Appl. No.: 17/846,571

(22) Filed: Jun. 22, 2022

(30) Foreign Application Priority Data
Sep. 7, 2021 (JP) 2021-145369

(51) Int. Cl. G06Q 30/02; G06Q 10/00

(52) U.S. Cl. CPC G06Q 30/0284; G06Q 10/20

(57) ABSTRACT

A non-transitory computer-readable recording medium stores a program for causing a computer to execute a process including estimating a usage period based on a user's usage status for each device in a system that provides a service at metered charge for the devices, calculating a first cost related to renewal of each device based on the estimated usage period, estimating a maintenance timing of each device from a failure history of each device, calculating a second cost related to maintenance of each device based on the maintenance timing of each device and the estimated usage period, generating a service cost of the service for each device, the service cost including the first cost and the second cost, and selecting a device to be used for the service based on the service cost generated for each device.

### CROSS-REFERENCE TO RELATED APPLICATION

This application is based upon and claims the benefit of priority of the prior Japanese Patent Application No. 2021-145369, filed on Sep. 7, 2021, the entire contents of which are incorporated herein by reference.

### FIELD

The embodiment discussed herein is related to a device selection method and an information processing apparatus.

### BACKGROUND

In recent years, a service with which hardware for a data center installed on the premises may be used with a monthly metered charge has been known. Assets are owned by a vendor side, and setup is also performed by the vendor side. A service user does not need to introduce information technology (IT) resources. A charge includes, for example, a fixed part (basic charge and optional charge) and a variable part (metered charge).

Japanese Laid-open Patent Publication No. 2002-34151 and Japanese Laid-open Patent Publication No. 2006-134022 are disclosed as related art.

### SUMMARY

According to an aspect of the embodiment, a non-transitory computer-readable recording medium stores a program for causing a computer to execute a process, the process including estimating a usage period based on a user's usage status for each of devices in a system that provides a service at metered charge for the devices, calculating a first cost related to renewal of each of the devices based on the estimated usage period, estimating a maintenance timing of each of the devices from a failure history of each of the devices, calculating a second cost related to maintenance of each of the devices based on the maintenance timing of each of the devices and the estimated usage period, generating a service cost of the service for each of the devices, the service cost including the first cost and the second cost, and selecting a device to be used for the service based on the service cost generated for each of the devices.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram (1) illustrating device selection according to an embodiment;

FIG. 1B is a diagram (2) illustrating the device selection according to the embodiment;

FIG. 2 is a diagram illustrating a cost related to device renewal according to the embodiment;

FIG. 3 is a diagram illustrating a cost related to device maintenance according to the embodiment;

FIG. 4 is a diagram illustrating an example of a failure rate;

FIG. 5 is a diagram illustrating a functional configuration of an information processing apparatus according to the embodiment;

FIG. 6 is a diagram illustrating an example of a flowchart of device selection processing according to the embodiment;

FIG. 7 is a diagram illustrating an example of a flowchart of user usage period estimation processing according to the embodiment;

FIG. 8 is a diagram illustrating an example of a flowchart of the number of times of maintenance estimation processing according to the embodiment;

FIG. 9A is a diagram (1) illustrating effects of the device selection processing according to the embodiment;

FIG. 9B is a diagram (2) illustrating the effects of the device selection processing according to the embodiment;

FIG. 10 is a diagram illustrating a hardware configuration example; and

FIG. 11 is a diagram illustrating a problem in a case where a device is selected.

### DESCRIPTION OF EMBODIMENT

In this service with which the hardware may be used with a monthly metered charge, if use of the service increases or the technology is innovated, in a provided hardware environment, new and old models are gradually mixed. In a case where a plurality of types of device that satisfies a service level agreement (SLA) exists, there is a problem in that it is difficult for a virtual environment provider (vendor) to select a device as to be an allocation destination of a job or data. This problem will be described.

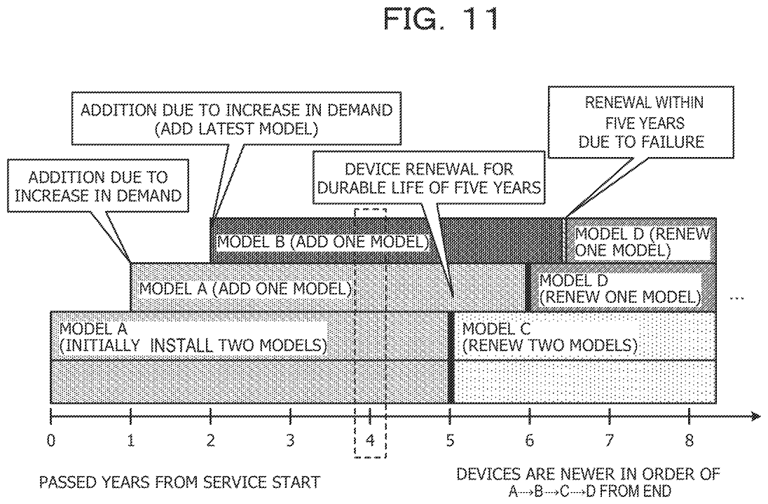

FIG. 11 is a diagram illustrating a problem in a case where a device is selected. As illustrated in FIG. 11, for a service user, two models A are installed at the time of service start, one model A is added one year later, and one model B is further added two years later. In a case where a durable life is five years, the device is renewed after five years of use. Furthermore, in a case of a failure, the device is renewed even in the middle of the five years. It is assumed that models A, B, C, and D be newer in an order from the end. In such a case, in a provided hardware environment, new and old models are mixed. It is difficult to determine which one of the model A and the model B is used for desired calculation by the service user after four years of use. For example, because the model A is older than the model B, a use price is low. However, it is expected that a maintenance cost is high since the model A has a short life. Because the model B is newer than the model A, the use price is high. However, it is expected that the maintenance cost is suppressed since the life is long. It is difficult for the service user to determine which one of the model A and the model B is to be used on the basis of these expectations. It is difficult for the virtual environment provider (vendor) to select a device used for the calculation.

Hereinafter, an embodiment will be described in detail with reference to the drawings. Note that the embodiments do not limit the present disclosure.

### Embodiment

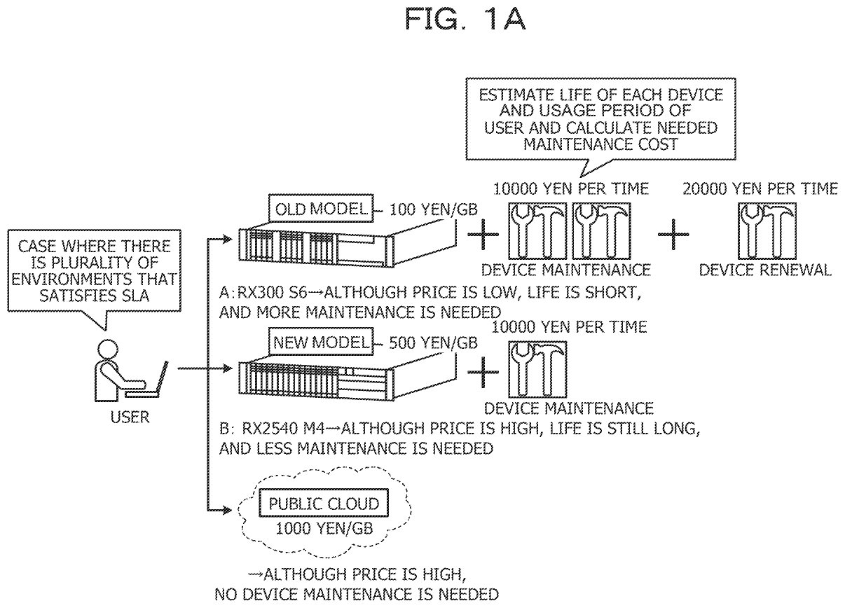

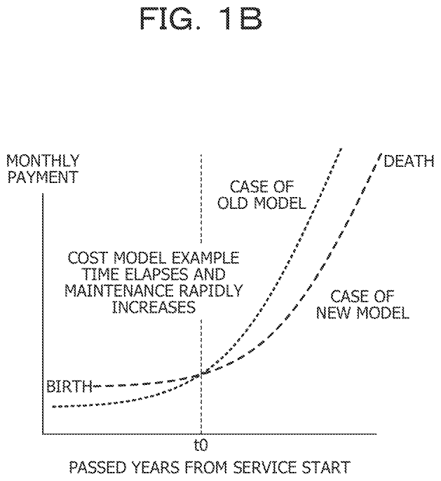

FIGS. 1A and 1B are diagrams illustrating device selection according to the embodiment. As illustrated in FIG. 1A, a user (service user) uses a service with which the user may use a device installed on the premises with monthly rate. In this service, when use of the service increases or the technology is innovated, in a provided device environment, new and old models are gradually mixed. In a case where there is a plurality of environments that satisfies a service level agreement (SLA), it is difficult for the user to determine which environment is to be used, and it is difficult for the service provider to select and propose a device to be used.

In FIG. 1A, it is assumed that models A and B be installed. The model A is older than the model B, is cheaper, has a shorter life, and needs more maintenance. For example, for the model A, a cost obtained by adding a metered unit price needed to use the model A, a cost related to device renewal in a case where an end of a durable life comes, and a cost related to device maintenance is estimated as a cost model. On the other hand, the model B is a new model, is more expensive than the model A, still has a longer life, and needs less maintenance. For example, for the model B, a cost obtained by adding a metered unit price needed to use the model B and a cost related to device maintenance is estimated as a cost model.

An information processing apparatus generates a cost model considering an estimated device life including a failure of each device and an estimated usage period of a user for each device and compares the cost models so as to select a lower-cost device as a device that uses resources (jobs and data). As a result, the user may select a lower-cost device in a case where a desired job or data is used.

Note that, in a public cloud, although a price is high, device maintenance is not needed. In the embodiment, a case will be described where the public cloud, which does not need the cost related to the device maintenance, is excluded.

As years pass from service start, maintenance due to failures rapidly increases. Therefore, monthly payment for the device rapidly increases. In FIG. 1B, a transition of monthly payments for a device in each of a case of a new model and a case of an old model is illustrated. In a case of the old model, from the service start to t0, the monthly payment is less than that of the new model. However, after t0, the monthly payment rapidly increases, and this increase is larger than that of the new model. This is because it is assumed that, although the monthly payment is lower than that of the new model since the metered unit price of the old model is low until t0, the maintenance rapidly increases from t0. On the other hand, in a case of a new model, although the monthly payment is more than that of the old model from the service start to t0, the monthly payment is reduced as compared with the old model after t0. This is because it is assumed that, although the monthly payment is higher than that of the old model since the metered unit price of the new model is high until t0, the number of times of maintenance be less than that of the old model after t0.

Therefore, the information processing apparatus generates a cost model considering an estimated device life including a failure of each device and an estimated usage period of a user for each device and compares the cost models so as to select a lower-cost device as a device that uses resources. The cost model here is, for example, a sum of a metered unit price for one month, an infrastructure usage, a cost related to device renewal, and a cost related to device maintenance.

The metered unit price is a unit price used when the device itself is used, and is, for example, a unit price per used GB when a hard disk is used or a unit price per device when the device itself is used. The infrastructure usage is a network usage or electric bills. The cost related to device renewal is a cost needed when a device is renewed after its durable life (for example, five years) and includes a cost needed for a work for installing a new device and data transfer. Note that the cost related to device renewal may include a cost incurred by temporarily using another environment while the device is stopped due to the device renewal. The cost related to device maintenance is a maintenance cost needed throughout an estimated device life, and includes an expected maintenance cost and an unexpected maintenance cost. Note that the cost related to device maintenance may include a cost incurred by temporarily using another environment while the device is stopped due to the device maintenance.

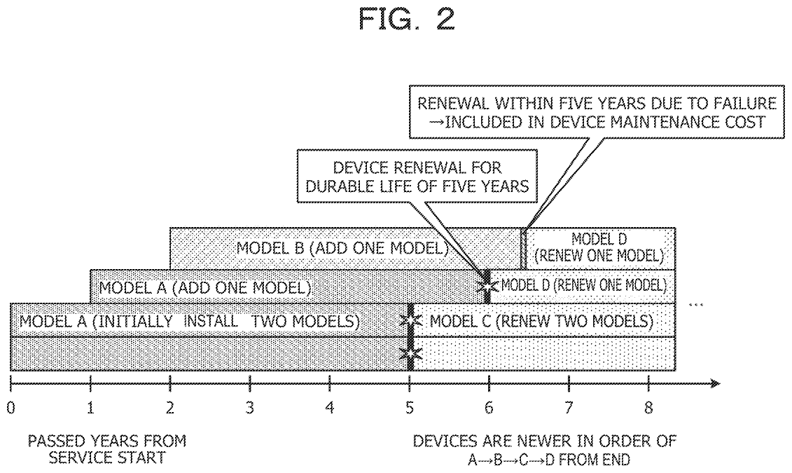

FIG. 2 is a diagram illustrating the cost related to device renewal according to the embodiment. In FIG. 2, for the service user, the two models A are installed at the time of service start, one model A is added one year later, and one model B is further added two years later. In a hardware environment provided by a service provider, new and old models are mixed.

In a case where a durable life is five years, the device is renewed after five years of use. Here, the two models A installed at the time of service start are renewed to models C after the durable life of five years. The model A added one year later is renewed to a model D after the durable life of five years. It is assumed that models A, B, C, and D be newer in an order from the end. Note that, although the model B is renewed to the model D after four years from the installation due to a failure, it is assumed that this renewal cost be included in the cost related to device maintenance.

The information processing apparatus calculates a cost C_{A,renewal} related to device renewal of the model A incurred after the durable life as in the formula (1). Note that C_{A,renewal} is a total of monthly-payment costs related to server renewal of the model A. The C_{A,ren_work} is a total of an installation work cost at the time of the server renewal of the model A. The C_{A,ren_alt} is a total of an alternative environment usage cost while the server is stopped at the time of the server renewal of the model A. The T_{life} is the number of times of payment from the installation during the durable life. If the durable life is five years, T_{life} is 60 times.

$${C}_{A , renewal} = \frac{{c}_{A , ren\_work} + {c}_{A , ren\_alt}}{{T}_{life}} \qquad ( 1 )$$

C_{A, renewal} . . . TOTAL OF MONTHLY-PAYMENT COSTS RELATED TO DEVICE RENEWAL OF SERVER A
c_{A, ren_work} . . . TOTAL OF INSTALLATION WORK COST AT THE TIME OF RENEWAL OF SERVER A
c_{A, ren_alt} . . . TOTAL OF ALTERNATIVE ENVIRONMENT USAGE COST DURING STOP AT THE TIME OF RENEWAL OF SERVER A
T_{life} . . . THE NUMBER OF TIMES OF PAYMENT FROM INSTALLATION THROUGH DURABLE LIFE

Note that, in a case where an estimated usage period is shorter than the durable life, it is sufficient for the information processing apparatus to set the cost C_{A,renewal} related to the device renewal of the model A to “0”. This is because the service ends before the device renewal.

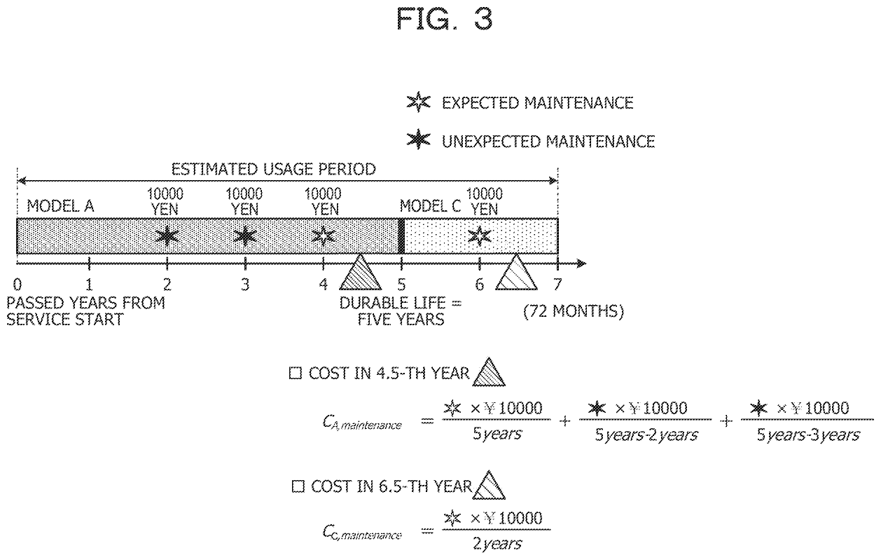

FIG. 3 is a diagram illustrating the cost related to device maintenance according to the embodiment. As illustrated in FIG. 3, a cost related to maintenance during the estimated usage period of the model A is illustrated. Here, the model A is used for the durable life of five years, and thereafter, a renewed model C is used. Expected maintenance occurs after four years of use and after six years of use, and unexpected maintenance occurs after two years of use and after three years of use.

The information processing apparatus calculates the cost C_{A,maintenance} related to the device maintenance of the model A as in the formula (2). Note that C_{A,maintenance} is a total of monthly-payment costs related to the device maintenance of the server of the model A. The C_{j,A,mai_work} is a total of an installation work cost (expected) at the time of j-th maintenance of the server of the model A. The C_{j,A,mai_alt} is a total of an alternative environment usage cost (expected) while the server is stopped at the time of the j-th maintenance of the server of the model A. The Tᵤₛₑ is the number of payments during a continuous usage period. The continuous usage period here is a period for which the same device is continuously used from installation and the length thereof is the durable life or less. The x_{i,A} is the number of payments from occurrence of i-th maintenance during the durable life. The d_{i,A,mai_work} is a total of an installation work cost (unexpected) at the time of the i-th maintenance of the server of the model A. The d_{i,A,mai_alt} is a total of an alternative environment usage cost (unexpected) while the server is stopped at the time of the i-th maintenance of the server of the model A.

$${C}_{A , maintenance} = {\begin{matrix}{\sum }_{j} \frac{{c}_{j , A , mai\_work} + {c}_{j , A , mai\_alt}}{{T}_{use}} & +\end{matrix}}_{\begin{matrix}EXPECTED \\ MAINTENANCE COST\end{matrix}} {\begin{matrix}{\sum }_{i} \frac{{d}_{i , A , {mai}_{work}} + {d}_{i , A , mai\_alt}}{{T}_{use} - {x}_{i , A}} & \end{matrix}}_{\begin{matrix}UNEXPECTED \\ MAINTENANCE COST\end{matrix}} \qquad ( 2 )$$

C_{A, maintenance} . . . TOTAL OF MONTHLY-PAYMENT COSTS RELATED TO DEVICE MAINTENANCE OF SERVER A
c_{j,A,mai_work} . . . TOTAL OF INSTALLATION WORK COST (EXPECTED) AT THE TIME OF MAINTENANCE OF SERVER A (j-TH)
c_{j,A,mai_alt} . . . TOTAL OF ALTERNATIVE ENVIRONMENT USAGE COST (EXPECTED) DURING STOP AT THE TIME OF MAINTENANCE OF SERVER A (j-TH)
Tᵤₛₑ . . . THE NUMBER OF TIMES OF PAYMENT DURING CONTINUOUS USAGE PERIOD
x_{i,A} . . . THE NUMBER OF TIMES OF PAYMENT FROM OCCURRENCE OF MAINTENANCE DURING DEVICE DURABLE LIFE (i-TH)
d_{i,A,mai_work} . . . TOTAL OF INSTALLATION WORK COST AT THE TIME OF MAINTENANCE OF SERVER A (i-TH) (COST OF UNEXPECTED MAINTENANCE)
d_{i,A,mai_alt} . . . TOTAL OF MONTHLY-PAYMENT COSTS RELATED TO DEVICE RENEWAL OF SERVER A (COST OF UNEXPECTED MAINTENANCE)

The cost C_{A,maintenance} related to the device maintenance of the model A after 4.5 years of use illustrated in FIG. 3 is calculated on the basis of the formula (2).

C_{A,maintenance}=1×10 thousand yen/60 months(=5 years×12 months)+1×10 thousand yen/36 months(=(5 years−2 years)×12 months)+1×10 thousand yen/24 months(=(5 years+3 years)×12 months)

Of this, 1×10 thousand yen/60 months is a monthly-payment cost corresponding to an expected maintenance cost after four years from the service start. The cost of 1×10 thousand yen/36 months is a monthly-payment cost corresponding to an unexpected maintenance cost after two years from the service start. The cost of 1×10 thousand yen/24 months is a monthly-payment cost corresponding to an unexpected maintenance cost after three years from the service start. The C_{A,maintenance} is a total of the monthly-payment costs obtained by adding these costs.

Furthermore, the cost C_{C,maintenance} related to the device maintenance of the model C after 6.5 years of use illustrated in FIG. 3 is also calculated on the basis of the formula (2).

C_{C,maintenance}=1×10 thousand yen/24 months(=2 years×12 months)
Of this, 1×10 thousand yen/24 months is a monthly-payment cost corresponding to an expected maintenance cost after one year of use in the continuous usage period following the device renewal after the durable life.

Here, C_{j,A,mai_work} and C_{j,A,mai_alt} in the formula (2) are respectively calculated on the basis of the following formulas (3) and (4).

Note that C′_{j,A,mai_work} is a j-th maintenance work cost. The y′_{j,A,mai_work} is the number of times of work. The C′_{j,A,mai_alt} is a j-th alternative environment usage cost during stop. The y′_{j,A,mai_alt} is the number of times of work.

C_{j,A,mai_work}=C′_{j,A,mai_work}×y′_{j,A,mai_work} (3)

C_{j,A,mai_alt}=C′_{j,A,mai_alt}×y′_{j,A,mai_alt} (4)

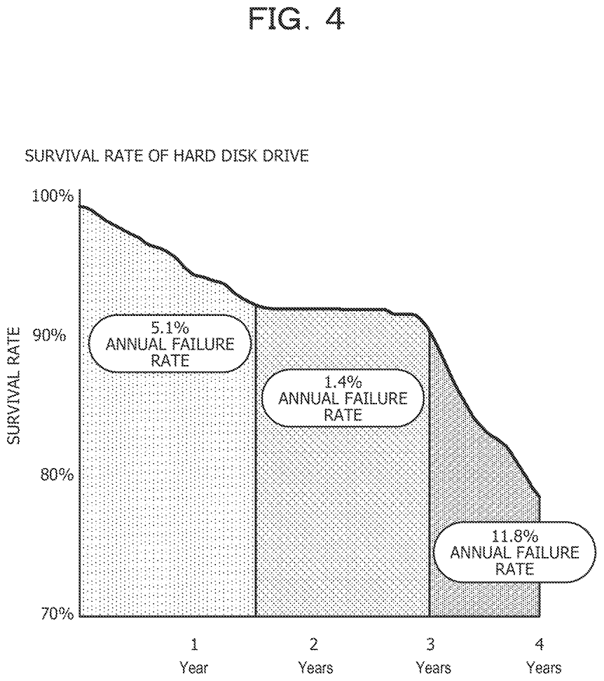

The y′_{j,A,mai_work} indicating the number of times of work in the formula (3) and the y′_{j,A,mai_alt} indicating the number of times of work in the formula (4) are calculated from the estimated device life. For example, the estimated device life may be acquired, from a durable life, a curved line of a failure rate, or the like issued by a manufacturer. Here, an example of a failure rate of a hard disk drive (HDD) mounted on a device will be described with reference to FIG. 4. FIG. 4 is a diagram illustrating an example of the failure rate. As illustrated in FIG. 4, an HDD has three clear failure rates. In the graph illustrated in FIG. 4, the X axis indicates the number of years of use, and the Y axis indicates a survival rate. From the service start to 1.5 years of use, the failure rate is 5.1%, from 1.5 years of use to three years of use, the failure rate is 1.4%, and from three years of use to four years of use, the failure rate is 11.8%. From such a curved line of the failure rate of the HDD, the estimated device life is acquired.

Then, y′_{j,A,mai_work} indicating the number of times of work in the formula (3) is calculated from the formula (5) including the estimated device life. The y′_{j,A,mai_alt} indicating the number of times of work in the formula (4) is calculated from the formula (6) including the estimated device life. Note that a period before a device failure in the formulas (5) and (6) corresponds to the estimated device life.

y′_{j,A,mai_work}=f(period before device failure,failure rate, and measurement data from which failure may be estimated) (5)

y′_{j,A,mai_alt}=g(period before device failure,failure rate, and measurement data from which failure may be estimated) (6)

Note that it has been described that the estimated device life may be acquired from the curved line of the failure rate. However, the embodiment is not limited to this, and the estimated device life may be estimated by artificial intelligence (AI) or machine learning (ML), such as a linear model and a neural network (NN), using the failure history data group of the device.

The continuous usage period needed to determine Tᵤₛₑ used in the formula (2) is acquired from the user usage period. It is sufficient that the user usage period be estimated as a value obtained by averaging the user usage periods of all the users. In another method, the user usage period may be estimated by the AI or the ML, such as the linear model and the NN, using a user information data group such as a user's usage status. For example, Tᵤₛₑ during the continuous usage period is calculated from the following formula (7).

Tᵤₛₑ=f(user information,measurement data from which user usage period may be estimated) (7)

If the user usage period of each user is determined at the time of contract, the user usage period may be that value.

[Functional Configuration of Information Processing Apparatus]

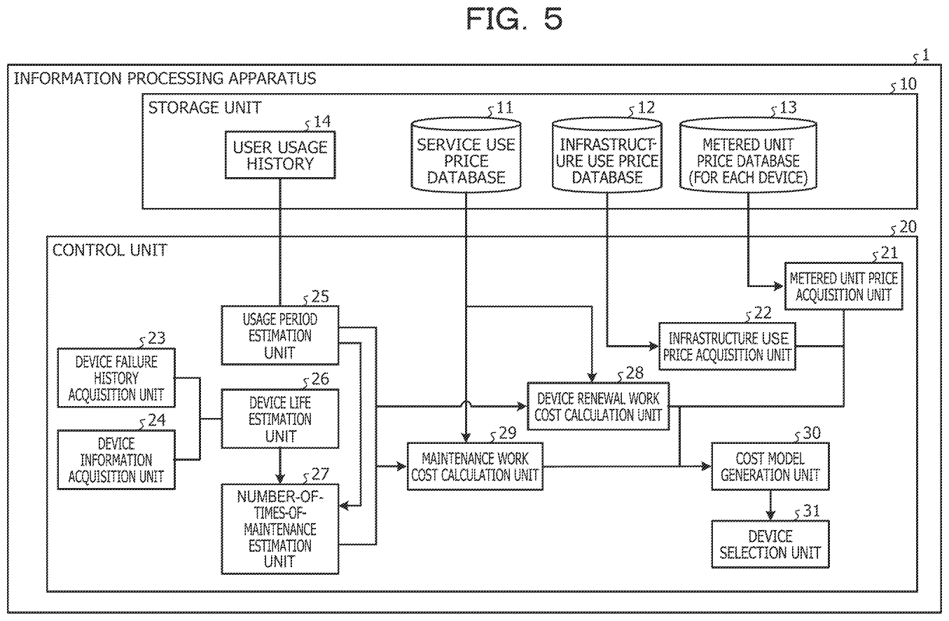

FIG. 5 is a diagram illustrating a functional configuration of the information processing apparatus according to the embodiment. As illustrated in FIG. 5, an information processing apparatus 1 includes a storage unit 10 and a control unit 20. The storage unit 10 includes a service use price database 11, an infrastructure use price database 12, a metered unit price database (for each device) 13, and a user usage history 14. The control unit 20 is a processing unit that manages the entire information processing apparatus 1 and includes a metered unit price acquisition unit 21, an infrastructure use price acquisition unit 22, a device failure history acquisition unit 23, a device information acquisition unit 24, a usage period estimation unit 25, a device life estimation unit 26, and a number-of-times-of-maintenance estimation unit 27. In addition, the control unit 20 includes a device renewal work cost calculation unit 28, a maintenance work cost calculation unit 29, a cost model generation unit 30, and a device selection unit 31.

The service use price database 11 stores a use price for a service. The use price for the service here includes, for example, an installation work cost for one device renewal and an alternative environment usage cost while the device is stopped. In addition, the use price for the service includes a work cost for one device maintenance and an alternative environment usage cost while the device is stopped. The infrastructure use price database 12 stores a unit price related to use of an infrastructure. The unit price related to the use of the infrastructure includes a network use price and electric bills. The metered unit price database (for each device) 13 stores a metered unit price used when the device itself is used and stores the metered unit price for each device. The metered unit price includes, for example, a unit price per used GB when a hard disk is used and a unit price per device when the device itself is used.

The user usage history 14 is information in which a user usage period of a user in the past is stored for each user.

The metered unit price acquisition unit 21 acquires a metered unit price of a target device from the metered unit price database (for each device) 13. The infrastructure use price acquisition unit 22 acquires a unit price related to the use of the infrastructure from the infrastructure use price database 12.

The device failure history acquisition unit 23 acquires a failure history of a device. For example, the device failure history acquisition unit 23 acquires a failure history data group of a device from information (not illustrated) in the storage unit 10. The device information acquisition unit 24 acquires device information. For example, the device information acquisition unit 24 acquires information regarding a durable life and a failure rate from information (not illustrated) in the storage unit 10. The durable life is, for example, a numerical value issued by a manufacturer and may be predetermined. The failure rate is, for example, a curved line issued by a manufacturer and may be information obtained from the curved line illustrated in FIG. 4, as an example.

The usage period estimation unit 25 estimates the user usage period. For example, in a case where the user usage period is predetermined, the usage period estimation unit 25 acquires the predetermined user usage period. In a case where the user usage period is not predetermined, the usage period estimation unit 25 may estimate an average value of user usage periods of respective users as the user usage period using the user usage periods of the users stored in the user usage history 14. Furthermore, in a case where the user usage period is not predetermined, the usage period estimation unit 25 may estimate the user usage period with the AI or the ML, such as the linear model and the NN, using the user information data group such as the user's usage status.

The device life estimation unit 26 estimates a device life. For example, the device life estimation unit 26 estimates the device life using the failure history data group of the device acquired by the device failure history acquisition unit 23. Furthermore, the device life estimation unit 26 estimates the device life using the information regarding the durable life and the failure rate acquired by the device information acquisition unit 24.

The number-of-times-of-maintenance estimation unit 27 estimates the number of times of maintenance (the number of times of work). For example, the number-of-times-of-maintenance estimation unit 27 estimates the number of times of work for expected maintenance using the formula (5) including a period to a device failure corresponding to the estimated device life. Furthermore, the number-of-times-of-maintenance estimation unit 27 estimates the number of times of work to use an alternative environment during stop for expected maintenance using the formula (6) including a period to a device failure corresponding to the estimated device life.

The device renewal work cost calculation unit 28 calculates a work cost related to device renewal. For example, the device renewal work cost calculation unit 28 acquires the installation work cost for the device renewal and the alternative environment usage cost while the device is stopped from the service use price database 11. Furthermore, the device renewal work cost calculation unit 28 acquires the user usage period estimated by the usage period estimation unit 25. Then, because the device is renewed if the user usage period is longer than the durable life, the device renewal work cost calculation unit 28 calculates a work cost for device renewal of the target device using the user usage period, the installation work cost for device renewal, and the alternative environment usage cost while the device is stopped. As an example, the device renewal work cost calculation unit 28 performs calculation using the formula (1).

The maintenance work cost calculation unit 29 calculates a work cost related to the device maintenance work. For example, the maintenance work cost calculation unit 29 acquires the work cost for the device maintenance and the alternative environment usage cost while the device is stopped from the service use price database 11. Furthermore, the maintenance work cost calculation unit 29 acquires the user usage period estimated by the usage period estimation unit 25. Furthermore, the maintenance work cost calculation unit 29 acquires the number of times of work (the number of times of maintenance) for the maintenance and the number of times of work (the number of times of maintenance) for alternative environment usage during stop, estimated by the number-of-times-of-maintenance estimation unit 27. Then, the maintenance work cost calculation unit 29 calculates a work cost related to a maintenance work of the target device using the user usage period, the work cost for the device maintenance, the alternative environment usage cost while the device is stopped, and the number of times of work. As an example, the maintenance work cost calculation unit 29 performs calculation using the formula (2).

The cost model generation unit 30 generates a cost model of a device. Note that the cost model generation unit 30 generates a cost model for each of a plurality of devices. For example, the cost model generation unit 30 generates a cost model of the target device by adding a metered unit price, a unit price related to the use of the infrastructure, a device renewal work cost, and a maintenance work cost, for the target device. Note that the cost model for the target device is a cost model converted into one month for the target device. In a case where there is a plurality of target devices, the cost model generation unit 30 generates a cost model for each device.

The device selection unit 31 selects a lower-cost device. For example, the device selection unit 31 compares the cost models for the respective target devices and selects a device with the lowest cost model.

[Flowchart of Device Selection Processing]

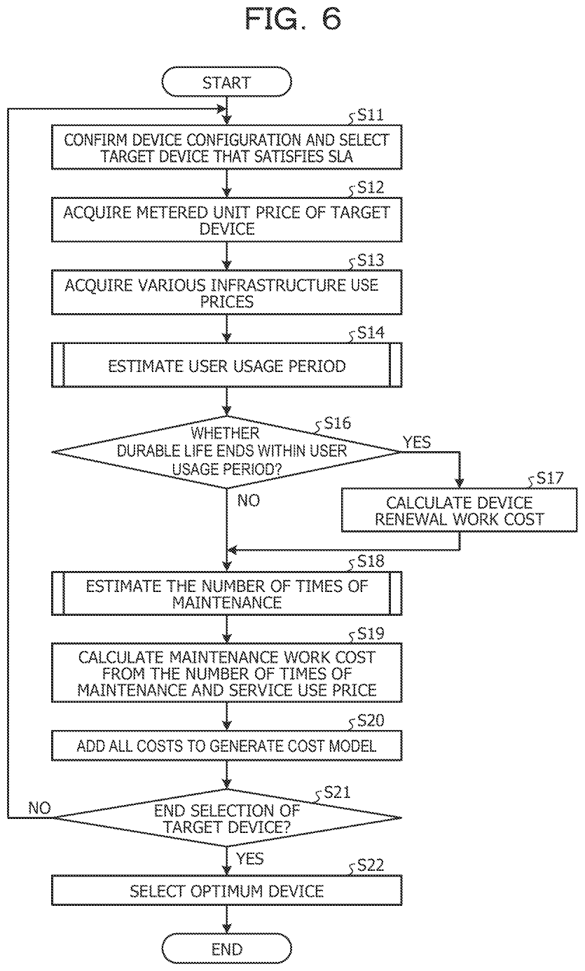

FIG. 6 is a diagram illustrating an example of a flowchart of device selection processing according to the embodiment. Note that it is assumed that the durable life be preset. As illustrated in FIG. 6, the information processing apparatus 1 confirms a device configuration and selects a target device that satisfies the SLA (step S11). The information processing apparatus 1 generates a cost model on the basis of processing in steps S12 to S20 for the selected target device.

The information processing apparatus 1 acquires a metered unit price of the target device by the metered unit price acquisition unit 21 (step S12). The information processing apparatus 1 acquires various infrastructure use prices by the infrastructure use price acquisition unit 22 (step S13). Then, the information processing apparatus 1 estimates a user usage period by the usage period estimation unit 25 (step S14). Note that a flowchart of the user usage period estimation processing will be described later.

Then, the information processing apparatus 1 determines whether or not the durable life ends within the user usage period by the device renewal work cost calculation unit 28 (step S16). In a case where it is determined that the durable life does not end within the user usage period (step S16; No), the information processing apparatus 1 proceeds to step S18.

On the other hand, in a case where it is determined that the durable life ends within the user usage period (step S16; Yes), the information processing apparatus 1 calculates a device renewal work cost by the device renewal work cost calculation unit 28 (step S17). For example, the device renewal work cost calculation unit 28 calculates the device renewal work cost of the target device by substituting the user usage period, the installation work cost for the device renewal, and the alternative environment usage cost while the device is stopped into the formula (1). Then, the information processing apparatus 1 proceeds to step S18.

In step S18, the information processing apparatus 1 estimates the number of times of maintenance by the number-of-times-of-maintenance estimation unit 27 (step S18). Note that a flowchart of the number of times of maintenance estimation processing will be described later.

Then, the information processing apparatus 1 calculates a maintenance work cost from the number of times of maintenance and the service use price by the maintenance work cost calculation unit 29 (step S19). For example, the maintenance work cost calculation unit 29 calculates the maintenance work cost of the target device by substituting the work cost for the device maintenance, the alternative environment usage cost while the device is stopped, and the number of times of work into the formulas (3) and (4) and further substituting the substitution result and the user usage period into the formula (2).

Then, the information processing apparatus 1 adds all the costs by the cost model generation unit 30 to generate the cost model of the target device (step S20). Then, the information processing apparatus 1 determines whether or not the selection of the target device ends (step S21). In a case where it is determined that the selection of the target device does not end (step S21; No), the information processing apparatus 1 proceeds to step S11 in order to execute processing on a next target device.

On the other hand, in a case where it is determined that the selection of the target device ends (step S21; Yes), the information processing apparatus 1 selects an optimum device by the device selection unit 31 (step S22). For example, the device selection unit 31 selects the target device with the lowest cost model from among all the target devices. Then, the information processing apparatus 1 ends the device selection processing.

[Flowchart of User Usage Period Estimation Processing]

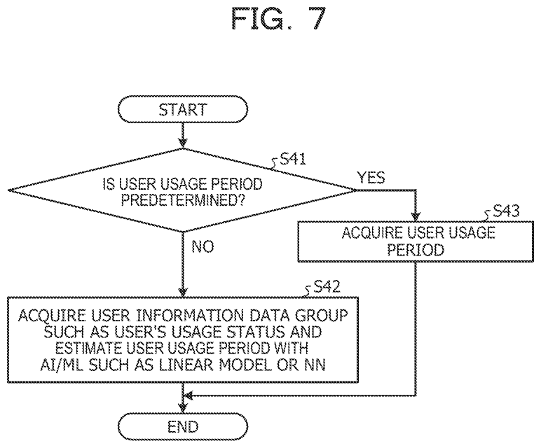

FIG. 7 is a flowchart illustrating an example of a flowchart of user usage period estimation processing according to the embodiment. As illustrated in FIG. 7, the usage period estimation unit 25 determines whether or not a user usage period is predetermined (step S41). In a case where it is determined that the user usage period is predetermined (step S41; Yes), the usage period estimation unit 25 acquires the determined user usage period (step S43). Then, the usage period estimation unit 25 ends the user usage period estimation processing.

On the other hand, in a case where it is determined that the user usage period is not predetermined (step S41; No), the usage period estimation unit 25 acquires the user information data group such as the user's usage status and estimates the user usage period with the AI or the ML, such as the linear model and the NN (step S42). Then, the usage period estimation unit 25 ends the user usage period estimation processing.

[Flowchart of the Number of Times of Maintenance Estimation Processing]

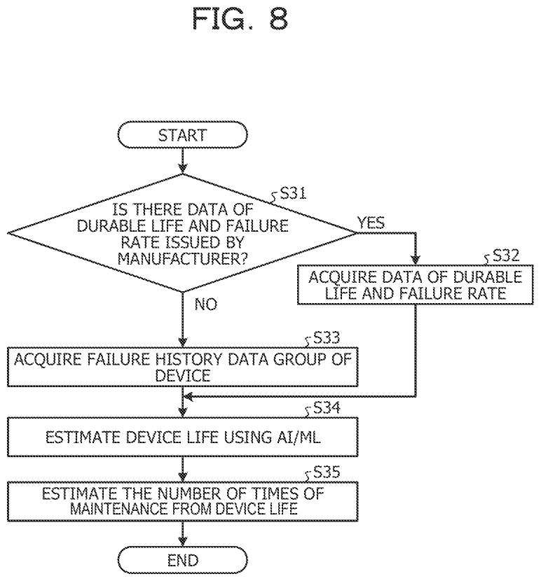

FIG. 8 is a diagram illustrating an example of a flowchart of the number of times of maintenance estimation processing according to the embodiment. As illustrated in FIG. 8, the information processing apparatus 1 determines whether or not there is data of a durable life and a failure rate issued by a manufacturer (step S31). In a case where it is determined that there is the data (step S31; Yes), the information processing apparatus 1 acquires the data of the durable life and the failure rate from the data issued by the manufacturer by the device information acquisition unit 24 (step S32). Then, the information processing apparatus 1 proceeds to step S34.

On the other hand, in a case where it is determined that there is no data (step S31; No), the information processing apparatus 1 acquires a failure history data group of the device by the device failure history acquisition unit 23 (step S33). Then, the information processing apparatus 1 proceeds to step S34.

In step S34, the information processing apparatus 1 estimates a device life with the AI or the ML using the acquired data or the failure history data group of the device by the device life estimation unit 26 (step S34). Then, the information processing apparatus 1 estimates the number of times of maintenance from the device life by the number-of-times-of-maintenance estimation unit 27 (step S35). For example, the number-of-times-of-maintenance estimation unit 27 estimates the number of times of maintenance work by assuming that the device life is the period before a device failure and inputting measurement data with which the failure rate and the failure may be estimated into the formula (5). Furthermore, the number-of-times-of-maintenance estimation unit 27 estimates the number of times of work for alternative environment usage during stop for maintenance by assuming that the device life is the period before a device failure and inputting measurement data with which the failure rate and the failure may be estimated into the formula (6). Then, the information processing apparatus 1 ends the number of times of maintenance estimation processing.

[Effects of Device Selection Processing]

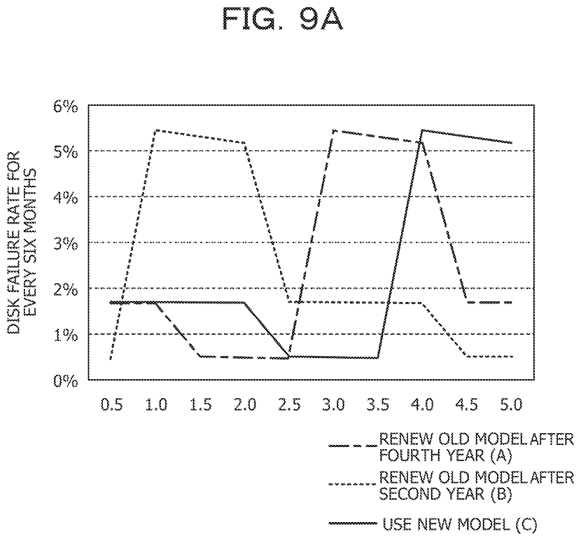

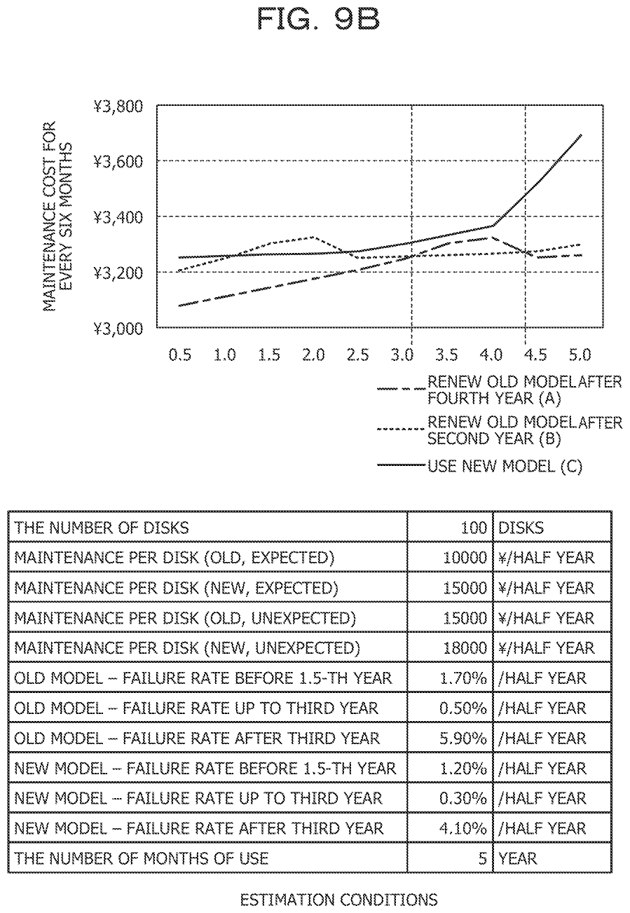

Here, effects of the device selection processing according to the embodiment will be described with reference to FIGS. 9A and 9B. FIGS. 9A and 9B are diagrams illustrating the effects of the device selection processing according to the embodiment. Here, the information processing apparatus 1 compares cost models in three environments after five years from the service start. For example, this is a case where the estimated usage period of the user is five years. The first environment (A) is a case where an old model is used for four years and then the old model is renewed to a new model. The second environment (B) is a case where the old model is used for two years and then the old model is renewed to the new model. The third environment (C) is a case where the new model is used from the service start.

The inventor has calculated a disk failure in consideration of the graph of the failure rate of the HDD illustrated in FIG. 4. For example, from the service start to 1.5 years of use, the failure rate is 5.1%, from the 1.5 years of use to three years of use, the failure rate is 1.4%, and from three years of use to four years of use, the failure rate is 11.8%. Of there, an integer part has been assumed as expected maintenance, and a fraction part has been assumed as unexpected maintenance. Exchange of a broken drive is performed for every six months, and a failure rate of the exchanged disk is reset to zero years of use. Here, only a maintenance cost will be focused and described while ignoring the metered cost, the infrastructure cost, and the device renewal cost.

As illustrated in FIG. 9A, graphs of disk failure rates in the three environments every six months are illustrated. The magnitude of the failure rate changes as time elapses. A period with the lowest failure rate in the environment (B) is from the service start to a half year of use and after 4.5 years of use. In the environment (A), the period is from 1.5 years of use to 2.5 years of use. In the environment (C), the period is from 2.5 years of use to 3.5 years of use.

Using such data of the failure rates, the information processing apparatus 1 estimates the maintenance costs in the three environments in a case where the estimated usage period of the user is set to five years using estimation conditions. In FIG. 9B, graphs of maintenance costs in the three environments every six months are illustrated. As illustrated in FIG. 9B, the environment (A) requires the lowest maintenance cost among the three environments for periods from the service start to three years of use and after 4.5 years of use. The environment (B) requires the lowest maintenance cost among the three environments for periods from three years of use to 4.5 years of use. Therefore, the service user (user) may suppress the maintenance cost to be low by using the environment in the period with the lowest maintenance cost. For example, the service user may suppress the maintenance cost to be low by using the environment (A) from the service start to three years of use and after 4.5 years of use and using the environment (B) from three years of use to 4.5 years of use. Then, as compared with a case where the environment (C) is continuously used, the service user may reduce the integrated cost for five years by 5.9%.

### Effects of Embodiment

According to the embodiment described above, the information processing apparatus 1 estimates a usage period based on a user's usage status for each of devices in a system that provides a service at metered charge for the devices. The information processing apparatus 1 calculates a first cost related to renewal of each of the devices based on the estimated usage period. The information processing apparatus 1 estimates a maintenance timing of each of the devices from the failure history of each of the devices. The information processing apparatus 1 calculates a second cost related to maintenance of each of the devices based on the maintenance timing of each of the devices and the estimated usage period. The information processing apparatus 1 generates a service cost of the service for each of the devices, the service cost includes the first cost and the second cost. The information processing apparatus 1 selects a device to be used for the service based on the service cost generated for each of the devices. According to the above configuration, the information processing apparatus 1 may propose a use device with low cost to a service user by calculating the cost related to the renewal and the cost related to the maintenance for each of the devices and generating the service cost for each of the devices.

Furthermore, according to the embodiment described above, the information processing apparatus 1 generates the service cost for each of the devices by adding costs including the first cost and the second cost. Then, the information processing apparatus 1 selects, as the device to be used for the service, a device of which the service cost has the smallest value among the service costs generated for the respective devices. According to the above configuration, the information processing apparatus 1 may propose a use device with the lowest cost to the service user.

Furthermore, according to the embodiment described above, the information processing apparatus 1 calculates the first cost by dividing the cost including the installation work cost at the time of device renewal by the number of payment obtained from the estimated usage period. According to the above configuration, the information processing apparatus 1 may compare the costs related to the device renewal for the respective devices by calculating the cost related to the device renewal for each device in consideration of the estimated usage period and may select a use device with low cost.

Furthermore, according to the embodiment described above, the information processing apparatus 1 calculates the second cost by integrating the maintenance work costs at the estimated maintenance timing and dividing the integrated maintenance work costs by the number of times of payments obtained from the estimated usage period. According to the above configuration, the information processing apparatus 1 may compare the costs related to the device maintenance for the respective devices by calculating the cost related to the device maintenance for each device in consideration of the estimated usage period and the maintenance timing and may select a use device with low cost.

Furthermore, according to the embodiment described above, the information processing apparatus 1 calculates an expected cost by integrating the maintenance work costs at the estimated maintenance timing of expected maintenance and by dividing the integrated maintenance work costs by the number of times of payment obtained from the estimated usage period. The information processing apparatus 1 also calculates an unexpected cost by integrating the maintenance work costs at the estimated maintenance timing of unexpected maintenance and by dividing the integrated maintenance work costs by the number of times of payment obtained from a period from the unexpected maintenance timing to the end of the estimated usage period. The information processing apparatus 1 adds the expected cost and the unexpected cost so as to calculate the second cost. According to the above configuration, the information processing apparatus 1 may accurately compare the costs related to the device maintenance for the respective devices by using the expected maintenance timing and the unexpected maintenance timing and may further select the use device with low cost.

[Others]

Note that any information described herein or illustrated in the drawings, including the processing procedures, control procedures, specific names, and various sorts of data and parameters may be arbitrarily modified unless otherwise noted.

Furthermore, each component of each device illustrated in the drawings is functionally conceptual, and is not needed to be physically configured as illustrated in the drawings. For example, specific forms of distribution and integration of each device are not limited to those illustrated in the drawings. For example, all or a part thereof may be configured by being functionally or physically distributed or integrated in optional units according to various types of loads, usage statuses, or the like.

Moreover, all or an optional part of individual processing functions performed in each device may be implemented by a central processing unit (CPU) and a program analyzed and executed by the CPU or may be implemented as hardware by wired logic.

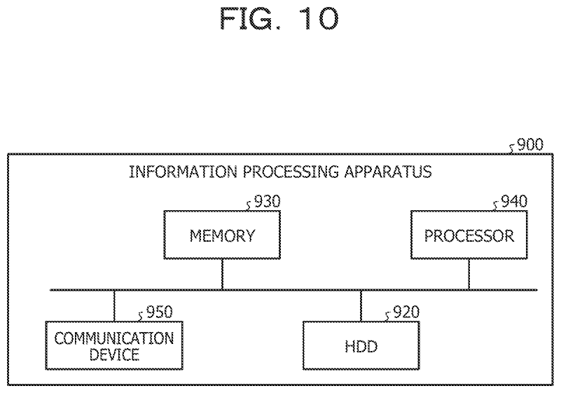

FIG. 10 is a diagram illustrating a hardware configuration example. As illustrated in FIG. 10, an information processing apparatus 900 includes a communication device 950, an HDD 920, a memory 930, and a processor 940. Furthermore, the individual units illustrated in FIG. 10 are mutually connected by a bus or the like.

The communication device 950 is a network interface card or the like and communicates with another device. The HDD 920 stores a program that operates the functions illustrated in FIG. 5 and databases (DBs).

The processor 940 reads a program that executes processing similar to that of each processing unit illustrated in FIG. 5 from the HDD 920 or the like, and loads the program on the memory 930, thereby activating a process that implements each function described with reference to FIG. 5 or the like. For example, this process executes a function similar to the function of each processing unit included in the information processing apparatus 1. For example, the processor 940 reads a program that has functions similar to the device failure history acquisition unit 23, the device information acquisition unit 24, the usage period estimation unit 25, the device life estimation unit 26, the number-of-times-of-maintenance estimation unit 27, or the like from the HDD 920 or the like. Then, the processor 940 executes a process for executing processing similar to those of the device failure history acquisition unit 23, the device information acquisition unit 24, the usage period estimation unit 25, the device life estimation unit 26, the number-of-times-of-maintenance estimation unit 27, or the like.

As described above, the information processing apparatus 900 operates as an information processing apparatus that executes a device selection method by reading and executing the program. Furthermore, the information processing apparatus 900 may also implement functions similar to the functions of the above-described embodiment by reading the above-described program from a recording medium by a medium reading device and executing the above-described read program. Note that the program is not limited to being executed by the information processing apparatus 900. For example, the present embodiment may be similarly applied to a case where another computer or server executes the program, or a case where these computer and server cooperatively execute the program.

This program may be distributed via a network such as the Internet. Furthermore, this program may be recorded on a computer-readable recording medium such as a hard disk, flexible disk (FD), compact disc read only memory (CD-ROM), magneto-optical disk (MO), or digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
estimating a usage period based on a user's usage status for each of devices in a system that provides a service at metered charge for the devices;
calculating a first cost related to renewal of each of the devices based on the estimated usage period;
estimating a maintenance timing of each of the devices from a failure history of each of the devices;
calculating a second cost related to maintenance of each of the devices based on the maintenance timing of each of the devices and the estimated usage period;
generating a service cost of the service for each of the devices, the service cost including the first cost and the second cost; and
selecting a device to be used for the service based on the service cost generated for each of the devices.

2. The non-transitory computer-readable recording medium according to claim 1, the process further comprising:
generate the service cost for each of the devices by adding costs that includes the first cost and the second cost; and
selecting, as the device to be used for the service, a device of which the service cost has a smallest value among the service costs generated for the respective devices.

3. The non-transitory computer-readable recording medium according to claim 1, the process further comprising:
calculating the first cost by dividing a cost that includes an installation work cost at a time of device renewal by a number of times of payment obtained from the estimated usage period.

4. The non-transitory computer-readable recording medium according to claim 1, the process further comprising:
calculating the second cost by integrating maintenance work costs at the estimated maintenance timing and by dividing the integrated maintenance work costs by a number of times of payment obtained from the estimated usage period.

5. The non-transitory computer-readable recording medium according to claim 4, the process further comprising:
calculating the second cost by adding an expected cost and an unexpected cost, the expected cost being calculated by integrating first maintenance work costs at the estimated maintenance timing of expected maintenance and by dividing the integrated first maintenance work costs by the number of times of payment obtained from the estimated usage period, the unexpected cost being calculated by integrating second maintenance work costs at the estimated maintenance timing of unexpected maintenance and by dividing the integrated second maintenance work costs by a number of times of payment obtained from a period from the maintenance timing of the unexpected maintenance to an end of the estimated usage period.

6. A device selection method, comprising:
estimating, by a computer, a usage period based on a user's usage status for each of devices in a system that provides a service at metered charge for the devices;
calculating a first cost related to renewal of each of the devices based on the estimated usage period;
estimating a maintenance timing of each of the devices from a failure history of each of the devices;
calculating a second cost related to maintenance of each of the devices based on the maintenance timing of each of the devices and the estimated usage period;
generating a service cost of the service for each of the devices, the service cost including the first cost and the second cost; and
selecting a device to be used for the service based on the service cost generated for each of the devices.

7. An information processing apparatus, comprising:
a memory; and
a processor coupled to the memory and the processor configured to:
estimate a usage period based on a user's usage status for each of devices in a system that provides a service at metered charge for the devices;
calculate a first cost related to renewal of each of the devices based on the estimated usage period;
estimate a maintenance timing of each of the devices from a failure history of each of the devices;
calculate a second cost related to maintenance of each of the devices based on the maintenance timing of each of the devices and the estimated usage period;
generate a service cost of the service for each of the devices, the service cost including the first cost and the second cost; and
select a device to be used for the service based on the service cost generated for each of the devices.
